(19) United States
(12) Patent Application Publication
(10) Pub. No.: US 2009/0284562 A1
(43) Pub. Date: Nov. 19, 2009

(54) PRINTING MEDIUM DETECTION SYSTEM, PRINTING MEDIUM DETECTION METHOD, AND PRINTING APPARATUS

(75) Inventors: Shintaro KOMURO, Shiojiri-shi (JP); Nobuhiko SHINOZAKI, Shiojiri-shi (JP); Tomoya TAKIKAWA, Shiojiri-shi (JP)

Correspondence Address: Workman Nydegger;1000 Eagle Gate Tower, 60 East South Temple, Salt Lake City, UT, 84111, US

(73) Assignee: Seiko Epson Corporation, Tokyo (JP)

(21) Appl. No.: 12/466,194

(22) Filed: May 14, 2009

(30) Foreign Application Priority Data
May 16, 2008 (JP) 2008-129209

(51) Int. Cl. B41J 29/38

(52) U.S. Cl. 347/16

(57) ABSTRACT

A printing medium detection system includes: a dark mark provided in a set portion for setting a printing medium on a retaining tray; a bright mark provided in the set portion for setting the printing medium on the retaining tray; and a reflective sensor that detects the existence of a printing medium by using light individually irradiated to the position of the dark mark and the position of the bright mark and reflected from the positions.

### BACKGROUND

1. Technical Field

The present invention relates to a printing medium detection system for detecting whether or not a printing medium is set in a set portion of a retaining tray, a printing medium detection method, and a printing apparatus such as a multi-function apparatus represented by a printer, a facsimile, or a copy machine, which has the printing medium detection system.

2. Related Art

Hereinafter, an ink jet printer as an example of a printing apparatus is described. As the ink jet printer, there is a printer which can selectively print on both of a soft printing medium such as a sheet and a film which is not self-supporting and a hard printing medium which is self-supporting and represented by an optical disc (CD-R, DVD-R, and the like) (for example, see JP-A-2005-59584). In addition, when the optical disc such as the CD-R is to be printed, a dedicated retaining tray prepared as an additional component is used, or an ink jet printer with a built-in retaining tray in a printer main body disclosed in JP-A-2005-59584 is used.

The retaining tray is provided with a shallow set concave portion for setting an optical disc such as a CD-R on its top surface, and the optical disc is set in the shallow set concave portion of the retaining tray to be transported.

The ink jet printer is provided with a printing medium detection device for detecting whether or not a printing medium is set in the set portion of the retaining tray. The printing medium detection device determines the existence or nonexistence of a printing medium by opening a hole at the bottom surface of a set portion which is covered when a printing medium is set in the retaining tray, irradiating light from a reflective sensor to the hole, and using a refractive index difference between the cases of existence and nonexistence of a printing medium.

However, although a printing medium is set in the set portion, in the case where the top surface of the printing medium corresponding to the hole position has a color having a low refractive index, for example, black, or in the case where the portion is being printed with an ink having a low refractive index already, there is a concern that it is wrongly determined that the printing medium does not exist.

### SUMMARY

An advantage of some aspects of the invention is that it provides a printing medium detection system for detecting whether or not a printing medium is set in a set concave portion on a retaining tray with good accuracy, a printing medium detection method, and a printing apparatus having the printing medium detection system.

According to an aspect of the invention, a printing medium detection system includes: a dark mark provided in a set portion for setting a printing medium on a retaining tray; a bright mark provided in the set portion for setting the printing medium on the retaining tray; and a reflective sensor that detects the existence of a printing medium by using light individually irradiated to the position of the dark mark and the position of the bright mark and reflected from the positions.

Here, the “dark mark” means a mark having a low refractive index, and the “bright mark” means a mark having a refractive index higher than the dark mark. The two marks may be distinguished by the reflective sensor, and the terms “dark” and “bright” have a relative meaning. In addition, the term “mark” is not limited to the given mark, and has a meaning including a 3D mark that can be distinguished by reflecting light using a hole and the like.

According to this aspect, a simple configuration provided with only two types of marks, that is, the dark mark and the bright mark and the reflective sensor which individually irradiates light to the positions of the two types of marks and detects the existence of a printing medium by using the reflecting light, is provided. With such a simple configuration, detection accuracy of the existence of a printing medium can be enhanced.

In the printing medium detection system according to this aspect of the invention, the retaining tray is configured to be transported in a transport direction, the reflective sensor is configured to be moved in a width direction of the retaining tray which is perpendicular to the transport direction, and the dark mark and the bright mark are disposed to be adjacent to each other in the movement direction of the reflective sensor or the transport direction of the retaining tray.

According to this aspect, by using a transporting unit (for example, a carriage) of the reflective sensor and a transporting unit (for example, a transporting roller) of the retaining tray, the reflective sensor can be moved to the position where the dark mark is provided and the position where the bright mark is provided. Therefore, there is no need to provide a new transport device or a complex moving unit to move the reflective sensor between the two points where the dark mark and the bright mark are positioned. In addition, in most cases, colors of adjacent two points on the top surface of a printing medium are the same and have the same brightness. Therefore, by detecting the existence of a printing medium at the adjacent two points, the detection accuracy of the existence of a printing medium can be significantly enhanced.

In the printing medium detection system according to this aspect of the invention, the retaining tray includes a set portion in which one of printing media with a plurality of applicable sizes can be set, and the dark mark and the bright mark are provided at positions commonly applicable to the printing media with the plurality of sizes.

According to this aspect, it is possible to detect the existence of a printing medium with one of the plural sizes by using the single dark mark and the single bright mark, which is efficient.

In the printing medium detection system according to this aspect of the invention, a plurality of combinations of the dark mark and the bright mark are provided, and the position patterns of the dark mark and the bright mark are different depending on the combinations.

According to this aspect, the number of detection points of the reflective sensor for detecting the existence of a printing medium is increased. In addition, the detection points are positioned according to the different position patterns. Therefore, there is little possibility that the arrangement of the points is matched with the arrangement of the dark color and the bright color on the top surface of the printing medium. Therefore, detection accuracy of the existence of a printing medium can be significantly increased.

According to another aspect of the invention, a printing medium detection method includes: a first detection step of disposing on a retaining tray having a set portion which is provided with a dark mark and a bright mark for setting a printing medium, a reflective sensor at a first detection position where the dark mark is provided to distinguish dark and bright colors; a second detection step of disposing the reflective sensor at a second detection position where the bright mark is provided to distinguish the dark and bright colors; and a determination step of determining on the basis of a first detection result of the first detection step and a second detection result of the second detection step, nonexistence of a printing medium when the first detection result represents the dark color and the second detection result represents the bright color, and determining existence of a printing medium when other combinations are represented.

According to this aspect, colors of two points, that is, of the first detection position provided with the dark mark and the second detection position provided with the bright mark are distinguished, and the existence or nonexistence of a printing medium is determined by a combination of the detection results. With such a simple configuration, effective and accurate printing medium detection is possible.

According to further another aspect of the invention, a printing apparatus includes: a retaining tray having a set portion for setting a printing medium; a transporting unit that transports the retaining tray; a printing medium detection system that detects whether or not a printing medium is set in the set portion; and a print executing device which prints a desired print on the printing medium transported to a print region of a print head, wherein the printing medium detection system is the printing medium detection device according to claim 1.

According to this aspect, the same operations and effects as those in the above-mentioned aspects can be exhibited. Therefore, error in detecting the existence of a printing medium which may occur due to the color of the top surface of the printing medium can be reduced.

### BRIEF DESCRIPTION OF THE DRAWINGS

The invention will be described with reference to the accompanying drawings, wherein like numbers reference like elements.

FIG. 1 is a perspective view illustrating the internal configuration of an ink jet printer.

FIG. 2 is a side sectional view illustrating the ink jet printer during detection.

FIG. 3 is a perspective view illustrating a retaining tray.

FIG. 4 is a plan view illustrating the retaining tray in which a printing medium having a diameter of 12 cm is set.

FIG. 5 is a plan view illustrating the retaining tray in which a printing medium having a diameter of 8 cm is set.

FIGS. 6A to 6C are block diagrams illustrating examples of determination of a determination step in a printing medium detection method.

FIG. 7 is a plan view illustrating another embodiment of a printing medium detection device.

FIG. 8 is a plan view illustrating still another embodiment of the printing medium detection device.

### DESCRIPTION OF EXEMPLARY EMBODIMENTS

Hereinafter, a printing medium detection system, a printing medium detection method executed by using the printing medium detection system, a printing apparatus having the printing medium detection system according to embodiments of the invention will be described. As the printing apparatus according to an exemplary embodiment of the invention, an ink jet printer 1 is employed first, and the entire configuration thereof is described schematically with reference to the accompanying drawings.

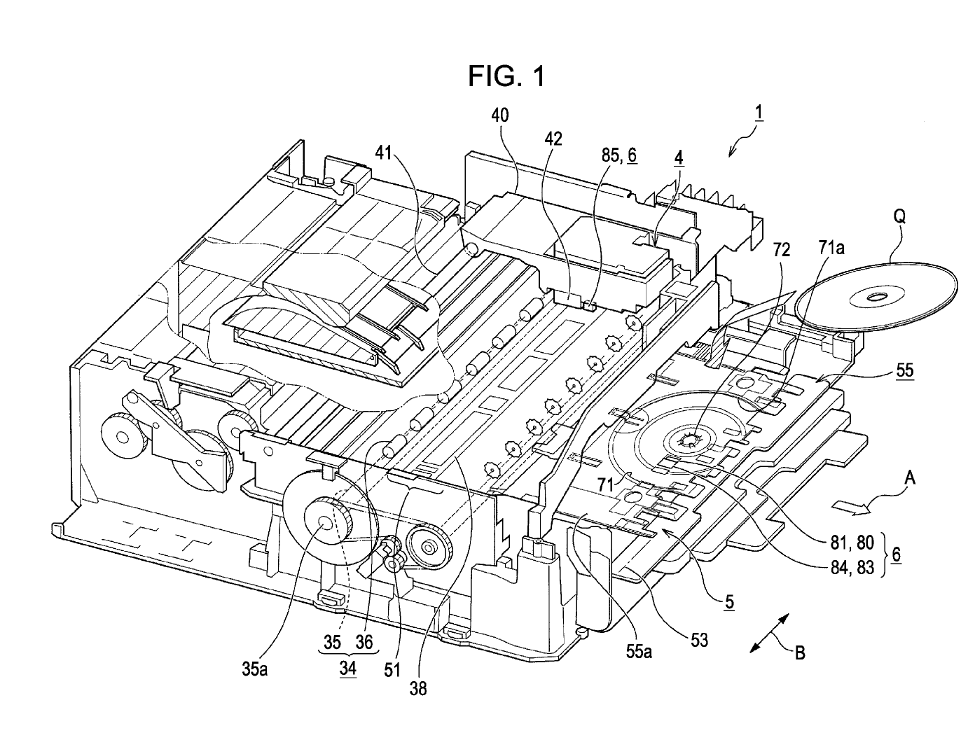

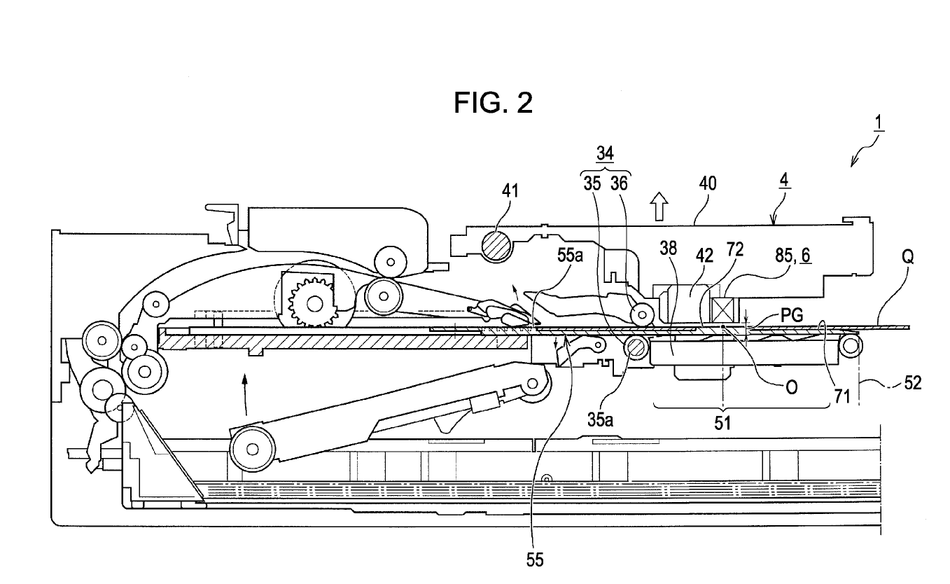

FIG. 1 is a perspective view illustrating the internal configuration of the ink jet printer when a retaining tray is disposed at a set position. FIG. 2 is a side sectional view schematically illustrating the internal structure of the ink jet printer when the retaining tray is disposed at a detection execution position. In addition, the ink jet printer 1 illustrated is a multi-function ink jet printer having an image reading device (scanner) not shown at its upper portion and is of a type that can print on both a soft printing medium such as a sheet and a film and a hard printing medium Q such as an optical disc including a CD-R and a DVD-R.

The ink jet printer 1 basically includes a printing medium transporting device 5 which moves the printing medium Q to and fro between a set position 53 and a receiving position by using a retaining tray 55 having a set concave portion 71 in a concave shape at a top surface 55a as a set unit for setting the printing medium Q, a printing medium detection system 6 described later for detecting the existence of the printing medium Q set in the set concave portion 71, a print executing device 4 which prints a desired print on the printing medium Q transported to a print execution position 51 of a print head 42.

The printing medium transporting device 5 basically includes the retaining tray 55 having the set concave portion 71 for setting the printing medium Q at the top surface 55a, and a transporting roller 34 constituted by a transport driving roller 35 which pinches the retaining tray 55 to exert transport force on the retaining tray 55 and a transport driven roller 36.

The retaining tray 55 is a member in a shape of a rectangular plate having a short depth. The set concave portion 71 for setting the printing medium Q and a retaining convex portion 72 provided at the center thereof for retaining the set printing medium Q are provided at the center position in a width direction B which is a little close to the front on the top surface 55a of the retaining tray 55. In addition, the printing medium Q that can be set in the retaining tray 55 may apply a CD-R/CD-RW/DVD-R/DVD-RW with applicable sizes such as diameters of 12 cm and 8 cm, Blu-ray Disc which has been spotlighted as a next-generation optical disc format, and other various types of optical discs including discs that will be developed.

The transporting roller 34 is constituted by the transporting driving roller 35 that is long in size and extends in the width direction B and plural transport driven rollers 36 which come in pressing contact with the peripheral surface of the transport driving roller 35 and are disposed at suitable intervals in the width direction B. In addition, the transport driving roller 35 is mounted to a roller driving shaft 35a which is horizontally hung between side frames not shown in the apparatus main body.

The print executing device 4 basically includes a carriage 40 provided above the print execution position 51, that is, the print execution region 51, the print head 42 mounted to the lower surface of the carriage 40, and a platen 38 provided below the print execution region 51.

The carriage 40 is a member which moves to and fro along a carriage guide shaft 41 hung along the width direction B perpendicular to a transport direction A of the printing medium Q. In addition, the print head 42 is a member which discharges an ink supplied from an ink supply device not shown through a nozzle not shown which is formed at the lower surface thereof to execute printing direct onto a printing surface at the top surface of the printing medium Q. In addition, the platen 38 is a transport guiding member of the printing medium Q which supports the lower surface of the printing medium Q transported to the print execution region 51 and defines a gap PG with the lower surface of the print head 42.

### Embodiment 1

Next, the configuration of the printing medium detection system 6 according to this embodiment which is applied to the ink jet printer 1 having the above-mentioned configuration, and the printing medium detection method according to this embodiment of the invention which is executed by using the printing medium detection system 6 will be described in detail with reference to the accompanying drawings.

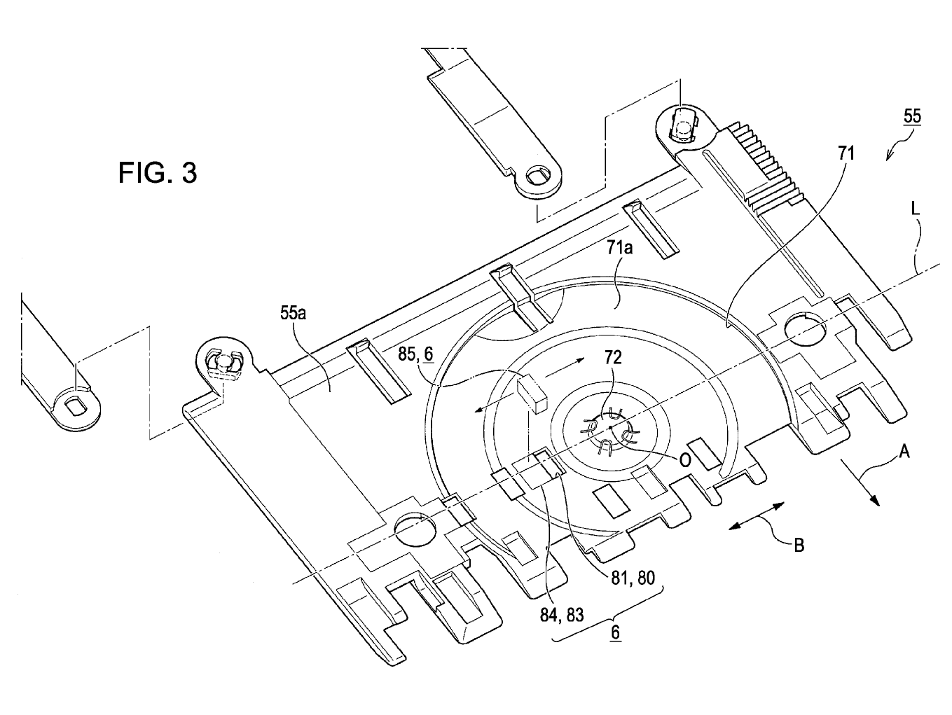

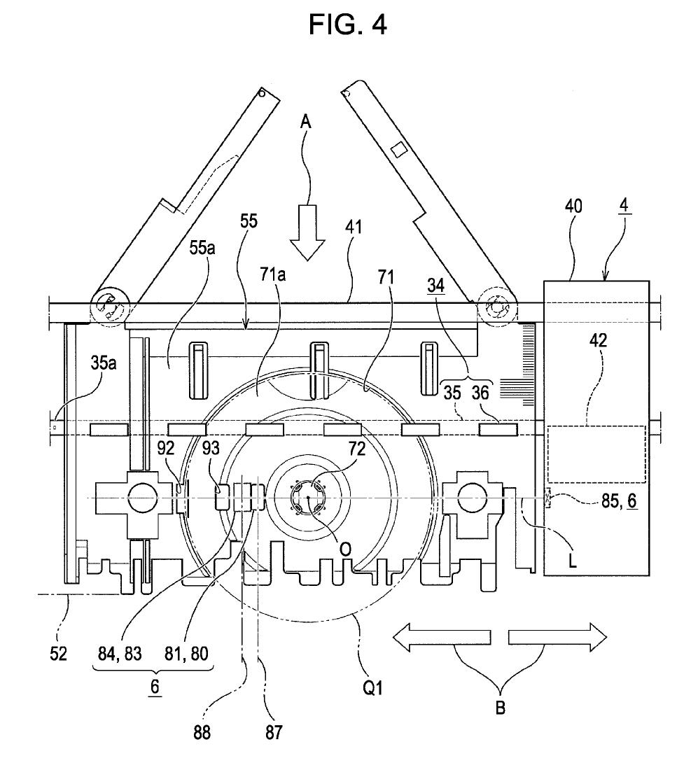

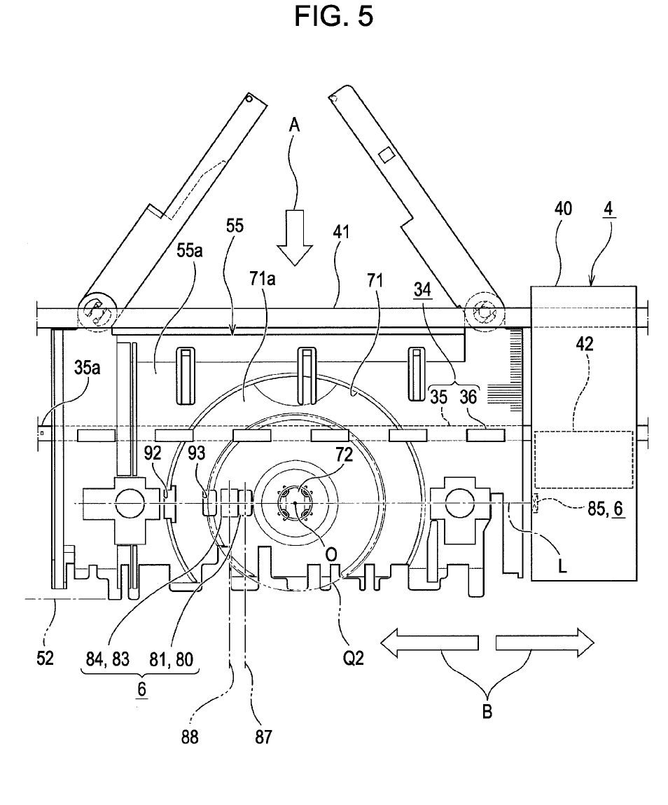

FIG. 3 is a perspective view illustrating the retaining tray. FIG. 4 is a plan view illustrating the retaining tray disposed at a detection execution position, in which the printing medium having a diameter of 12 cm is set. In addition, FIG. 5 is a plan view illustrating the retaining tray disposed at the detection execution position, in which the printing medium having a diameter of 8 cm is set.

The printing medium detection system 6 in this embodiment basically includes a dark mark 80 provided in the set concave portion 71 for setting the printing medium Q on the retaining tray 55, a bright mark 83 provided in the set concave portion 71 for setting the printing medium Q on the retaining tray 55, and a reflective sensor 85 for detecting the printing medium Q using light irradiated to the dark mark 80 and the bright mark 83 and reflected therefrom.

In this embodiment, the dark mark 80 is configured as a hole 81 which is formed at a bottom surface 71a of the set concave portion 71 of the retaining tray 55 and is rectangular from a plan view. On the other hand, the bright mark 83 is configured as a white coat 84 which is coated on the bottom surface 71a of the set concave portion 71 adjacent to the hole 81 in a scanning direction B and is rectangular from the plan view.

In addition, the dark mark 80 and the bright mark 83 are provided on a straight line L extending along the width direction B passing through the center O of the retaining convex portion 72 of the retaining tray 55. In addition, the dark mark 80 and the bright mark 83 are provided at internal positions of the set concave portion 71 which are commonly applicable to the printing medium Q1 having the diameter of 12 cm illustrated in FIG. 4 and the printing medium Q2 having the diameter of 8 cm illustrated in FIG. 5.

The reflective sensor 85 is mounted to the lower surface of the carriage 40 at such a position that the reflective sensor 85 passes the dark mark 80 and the bright mark 83 when the retaining tray 55 is disposed at the detection execution position 52 illustrated in FIGS. 4 and 5. In addition, the reflective sensor 85 used in this embodiment has such a sensitivity that the reflective sensor 85 can at least distinguish the light irradiated to the dark mark 80 and reflected therefrom from the light irradiated to the bright mark 83 and reflected therefrom.

The printing medium detection method executed by using the printing medium detection system 6 includes: (1) a first detection step; (2) a second detection step; and (3) a determination step descried as follows.

### 1. First Detection Step

The first detection step is a step of distinguishing the dark color and the bright color by disposing the reflective sensor 85 at a first detection position 87 where the dark color 80 is provided.

Specifically, the retaining tray 55 is moved to the detection execution position 52 by driving the transporting roller 34. Next, the carriage 40 that waits at a home position is moved to a return position on the opposite side thereof to dispose the reflective sensor 85 at the first detection position 87. In addition, light is irradiated from the reflective sensor 85 to the position of the dark mark 80, and by using the light reflecting therefrom, the dark color and the bright color are distinguished.

### 2. Second Detection Step

The second detection step is a step of distinguishing the dark color and the bright color by disposing the reflective sensor 85 at a second detection position 88 where the bright color 83 is provided.

Specifically, while the retaining tray 55 is disposed at the detection execution position 52, the reflective sensor 85 disposed at the first detection position 87 is moved further to the return position to be disposed at the second detection position 88. In addition, light is irradiated from the reflective sensor 85 to the position of the bright mark 83, and by using the light reflecting therefrom, the dark color and the bright color are distinguished.

### 3. Determination Step

The determination step is a step of determining the existence or nonexistence of the printing medium Q on the retaining tray 55 on the basis of a first detection result of the first detection step and a second detection result of the second detection step. In addition, when the first detection result represents the dark color and the second detection result represents the bright color, it is determined that the printing medium Q does not exist. When other combinations are represented, it is determined that the printing medium Q exists.

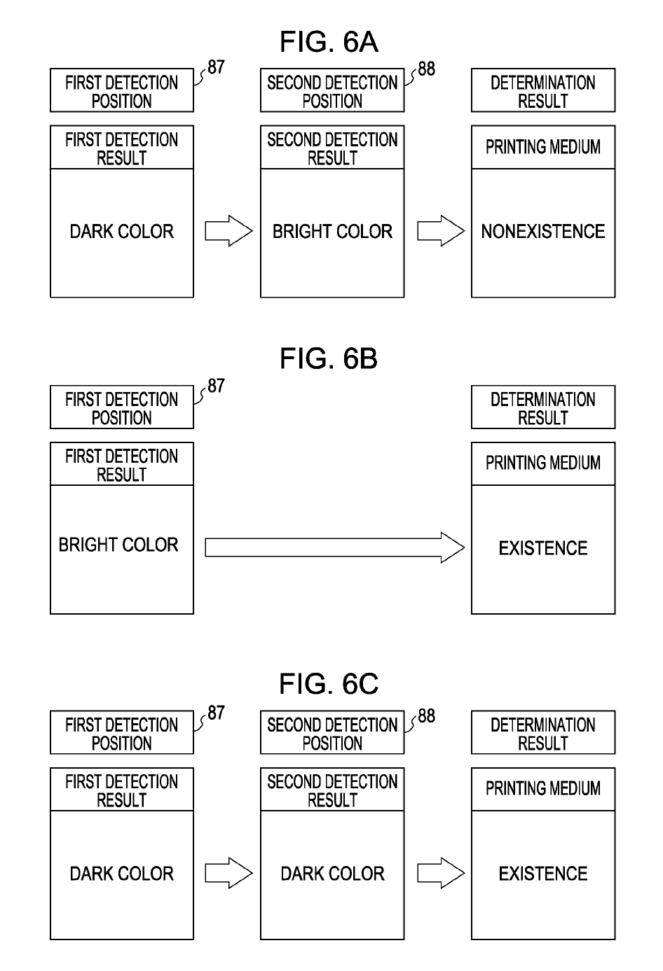

FIGS. 6A to 6C are block diagrams illustrating examples of determination of the determination step. Specifically, as illustrated in FIG. 6A, when the first and the second detection results represent the dark and the bright colors, respectively, the dark mark 80 and the bright mark 83 provided at the bottom surface 71a of the set concave portion 71 of the retaining tray 55 are recognized as it is. Therefore, it is determined that the printing medium Q does not exist.

As illustrated in FIG. 6B, when the first detection result represents the bright color, the dark mark 80 provided at the bottom surface 71a of the set concave portion 71 of the retaining tray 55 is not recognized. Therefore, it is instantly determined that the printing medium Q exists. In addition, as illustrated in FIG. 6C, when the first and the second detection results represent the dark color, it means that the bright mark 83 provided at the bottom surface 71a of the set concave portion 71 of the retaining tray 55 is not recognized. Therefore, as in FIG. 6B, it is determined that the printing medium Q exists.

### Embodiment 2

The printing medium detection system 6, the printing medium detection method executed by using the printing medium detection system 6, and the printing apparatus 1 having the printing medium detection system 6 basically have the above-mentioned configurations. However, modifications, omissions, and the like of the partial configurations can be made without departing from the spirit and scope of the invention.

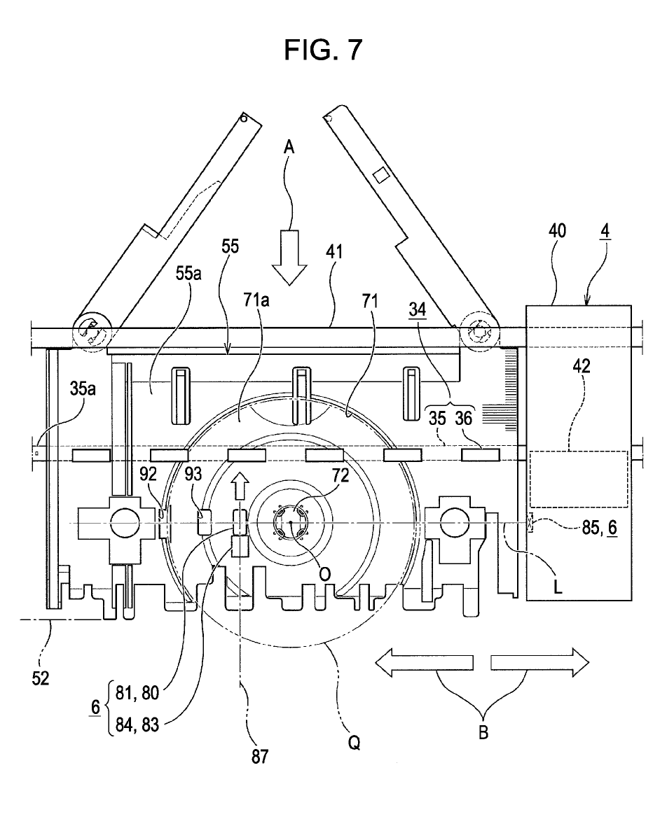

FIG. 7 is a plan view illustrating a difference example of the positions of the dark mark and the bright mark according to another embodiment of the invention. Specifically, instead of providing the bright mark 83 to be adjacent to the dark mark 80 in the scanning direction B of the reflective sensor 85, as illustrated in FIG. 7, the bright mark 83 may be provided to be adjacent to the dark mark 80 in the transport direction A of the retaining tray 55. In addition, in this embodiment illustrated in FIG. 7, after detecting the dark mark 80 at the first detection position 87 is terminated, while the position of the reflective sensor 85 is fixed, the retaining tray 55 is moved back slightly by driving the transporting roller 34 in the reverse direction to the transport direction A of the predetermined step so that the bright mark 83 can be disposed right under the reflective sensor 85. This enables determination.

### Embodiment 3

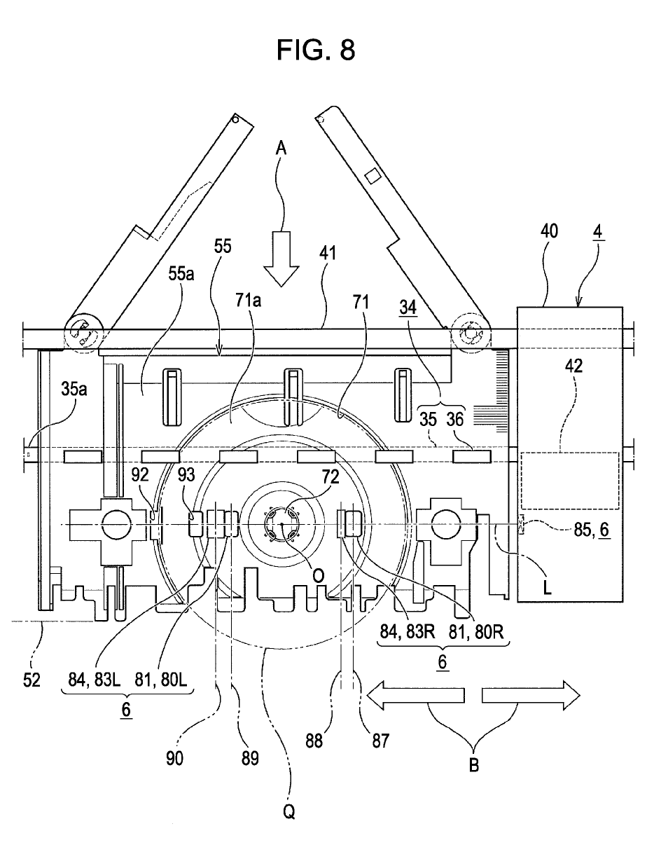

FIG. 8 is a plan view illustrating plural combinations of the dark mark and the bright mark according to still another embodiment of the invention. Not only a combination of the dark mark 80 and the bright mark 83, but plural combinations thereof can be provided. In addition, when the plural combinations of the dark mark 80 and the bright mark 83 are provided, position patterns of the dark mark 80 and the bright mark 83 may be different from each other depending on the combinations. Moreover, in FIG. 8, on the straight line L parallel to the width direction B passing the center O of the retaining concave portion 72 of the retaining tray 55, two pairs of dark marks 80L and 80R and bright marks 83L and 83R are provided on the left and the right, respectively, with the retaining concave portion 72 interposed therebetween.

In addition, widths and positions of the dark mark 80R and the bright mark 83R on the right are difference from those of the dark mark 80L and the bright mark 83L on the left. Accordingly, the incidence of error in detection due to the color consistency with the top surface of the printing medium Q can be reduced. In addition, in this embodiment illustrated in FIG. 8, third and fourth detection positions 89 and 90 in addition to the first and second detection positions 87 and 88, that is, total four detection positions are provided, and this contributes to an increase in detection accuracy of the printing medium Q.

### Other Embodiments

In addition, in the retaining tray 55, edge detection holes 92 and 93 for detecting edges of a printing medium Q1 having a diameter of 12 cm and a printing medium Q2 having a diameter of 8 cm are provided, and when portions thereof are provided on the set concave portion 71, the two edge detection holes 92 and 93 can be used as the dark mark 80.

Furthermore, in addition to the hole 81, the dark mark 80 may employ the retaining tray 55 itself which has a dark color such as black, a coat applied to the upper surface 55a of the retaining tray 55, or a seal attached. Similarly, the bright mark 83 is not limited to the white coat 84 and may employ the retaining tray 55 itself which has a bright color such as white or a fluorescent color having high reflectance or a seal attached to the top surface 55a of the retaining tray 55.

In addition, the printing medium detection system 6 and the printing apparatus 1 according to the embodiments of the invention may have a structure applicable only to the hard printing medium Q in addition to the structure applicable to both of the soft and hard printing media Q. Therefore, the printing medium detection system 6 is not limited to the printing device such as the ink jet printer described above and may apply a DVD player or a personal computer.

What is claimed is:

1. A printing medium detection system comprising:
a dark mark provided in a set portion for setting a printing medium on a retaining tray;
a bright mark provided in the set portion for setting the printing medium on the retaining tray; and
a reflective sensor that detects the existence of a printing medium by using light individually irradiated to the position of the dark mark and the position of the bright mark and reflected from the positions.

2. The printing medium detection system according to claim 1,
wherein the retaining tray is configured to be transported in a transport direction,
the reflective sensor is configured to be moved in a width direction of the retaining tray which is perpendicular to the transport direction, and
the dark mark and the bright mark are disposed to be adjacent to each other in the movement direction of the reflective sensor or the transport direction of the retaining tray.

3. The printing medium detection system according to claim 2,
wherein the retaining tray includes a set portion in which one of printing media with a plurality of applicable sizes can be set, and
the dark mark and the bright mark are provided at positions commonly applicable to the printing media with the plurality of sizes.

4. The printing medium detection system according to claim 2,
wherein a plurality of combinations of the dark mark and the bright mark are provided, and
the position patterns of the dark mark and the bright mark are different depending on the combinations.

5. A printing medium detection method comprising:
a first detection step of disposing on a retaining tray having a set portion which is provided with a dark mark and a bright mark for setting a printing medium, a reflective sensor at a first detection position where the dark mark is provided to distinguish dark and bright colors;
a second detection step of disposing the reflective sensor at a second detection position where the bright mark is provided to distinguish the dark and bright colors; and
a determination step of determining on the basis of a first detection result of the first detection step and a second detection result of the second detection step, nonexistence of a printing medium when the first detection result represents the dark color and the second detection result represents the bright color, and determining existence of a printing medium when other combinations are represented.

6. A printing apparatus comprising:
a retaining tray having a set portion for setting a printing medium;
a transporting unit that transports the retaining tray;
a printing medium detection system that detects whether or not a printing medium is set in the set portion; and
a print executing device which prints a desired print on the printing medium transported to a print region of a print head,
wherein the printing medium detection system is the printing medium detection device according to claim 1.
